(19) United States
(12) Patent Application Publication
(10) Pub. No.: US 2015/0379990 A1
(43) Pub. Date: Dec. 31, 2015

(54) DETECTION AND ENHANCEMENT OF MULTIPLE SPEECH SOURCES

(71) Applicant: Rajeev Conrad Nongpiur, Palo Alto, CA (US)

(72) Inventor: Rajeev Conrad Nongpiur, Palo Alto, CA (US)

(21) Appl. No.: 14/745,454

(22) Filed: Jun. 21, 2015

Related U.S. Application Data
(60) Provisional application No. 62/018,663, filed on Jun. 30, 2014.

(51) Int. Cl. G10L 15/20; G10L 25/93; G10L 25/84

(52) U.S. Cl. CPC G10L 15/20; G10L 25/84; G10L 25/93

(57) ABSTRACT

A new method for enhancing the speech of multiple speakers in an enclosure (e.g., home, office, etc) using a microphone array is developed. In the method, the direction of arrival of speech sources and non-speech sources are determined and a beamformer-response mask to enhance and suppress the desired and non-desired acoustic sources, respectively, is constructed. To obtain a beamformer that closely approximates the mask, combinations of pre-computed beamformers are optimally combined together.

### RELATED APPLICATIONS

This application claims priority to U.S. Provisional Patent Application No. 62/018,663, filed Jun. 30, 2014, entitled DETECTION AND ENHANCEMENT OF MULTIPLE SPEECH SOURCES, the contents of which are incorporated by reference herein in their entirety for all purposes.

### BACKGROUND

This invention generally relates to detection and enhancement of acoustic sources. More particularly, embodiments of this invention relate to the detection and enhancement of speech of multiple talkers or acoustic sources from different directions in an indoor environment, such as a home or an office.

Detection and enhancement of speech sources in an indoor environment is a challenge. Interference may come from many sources including music system, television, babble noise, refrigerator hum, washing machine, lawn mower, printer, and vacuum cleaner.

When used in an indoor environment a microphone may be used to receive sound from occupants within the environment. As the distance increases, the signal becomes more susceptible to noise and distortion.

When focusing on cost, power consumption or mobility, a manufacturer may limit the processing power of the devices or the size of the power-supply battery. A manufacturer's desire to keep costs down may reduce the accuracy and quality to a point that is much lower than their customers' expectations. There is room for improvement for a speech detection and enhancement system, especially in indoor environments. There is a need for a system that detects and enhances multiple speech sources at a low computational cost and at the same time is sensitive, accurate, and has minimal latency.

It will be appreciated that these systems and methods are novel, as are applications thereof and many of the components, systems, methods and algorithms employed and included therein. It should be appreciated that embodiments of the presently described inventive body of work can be implemented in numerous ways, including as processes, apparata, systems, devices, methods, computer readable media, computational algorithms, embedded or distributed software and/or as a combination thereof. Several illustrative embodiments are described below.

### SUMMARY

A system that enhances speech from desired multiple speakers in an indoor environment using a microphone array. The system includes a method for determining the direction of arrival of speech sources and non-speech sources. A beamformer-response mask is constructed to enhance and suppress the desired and non-desired acoustic sources, respectively. To obtain a beamformer that closely approximates the mask, several pre-computed perfect (or near perfect) linear-phase beamformers are then optimally combined together.

### BRIEF DESCRIPTION OF THE DRAWINGS

The inventive body of work will be readily understood by referring to the following detailed description in conjunction with the accompanying drawings, in which:

FIG. 1 illustrates a beamformer with capability for processing and update of coefficients;

FIG. 2 illustrates a realization of FIG. 1 in greater detail;

FIG. 3 illustrates an alternate realization of FIG. 1 in greater detail;

FIG. 4 illustrates an acoustic activity detector;

FIG. 5 illustrates a speech detector;

FIG. 6 illustrates an exemplary method to compute the acoustic-magnitude profile from various directions;

FIG. 7 illustrates an exemplary beamformer mask across the frequency and angular directions;

### DETAILED DESCRIPTION

A detailed description of the inventive body of work is provided below. While several embodiments are described, it should be understood that the inventive body of work is not limited to any one embodiment, but instead encompasses numerous alternatives, modifications, and equivalents. In addition, while numerous specific details are set forth in the following description in order to provide a thorough understanding of the inventive body of work, some embodiments can be practiced without some or all of these details. Moreover, for the purpose of clarity, certain technical material that is known in the related art has not been described in detail in order to avoid unnecessarily obscuring the inventive body of work.

In the text which follows a reference to a “beamformer” is a reference to a spatial filter that operates on the output of an array of sensors in order to enhance the amplitude of a coherent wavefront relative to background noise and directional interference. In the text which follows an abbreviation “DOA” is used as an acronym for “direction of arrival”. In the text which follows reference to “beamformer-coefficient” is intended as a reference to adaptive beamforming algorithms with real-value coefficients.

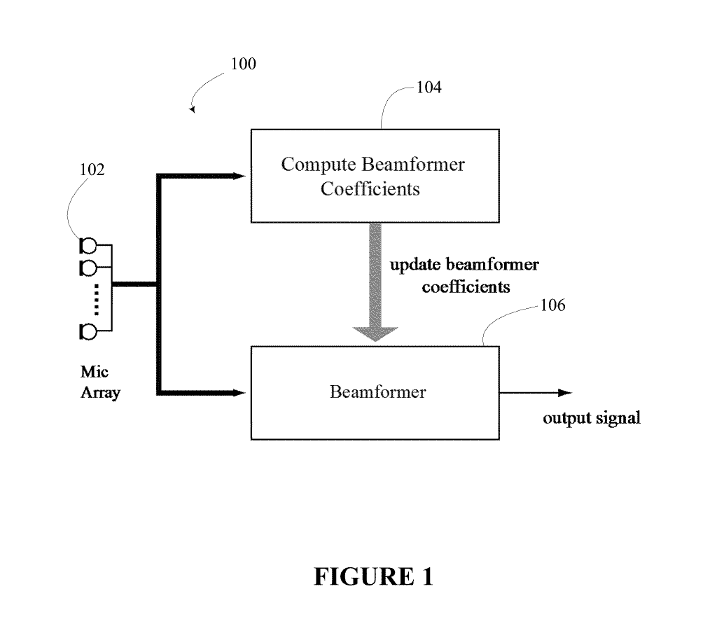

FIG. 1 illustrates a block diagram of a system 100 for processing and updating the coefficients of a beamformer so as to detect and enhance desired speech sources from multiple talkers from different directions in the presence of noise. The system 100 includes a microphone array 102, a beamformer-coefficient processing module 104, and a beamformer 106.

The beamformer-coefficient processing module 104 uses the signal from the microphone array 102 to detect the presence of speech and non-speech sources from various directions, and then computes coefficients to enhance desired speech sources.

The beamformer module 106 is updated with the coefficients computed by module 104 to enhance the desired speech sources.

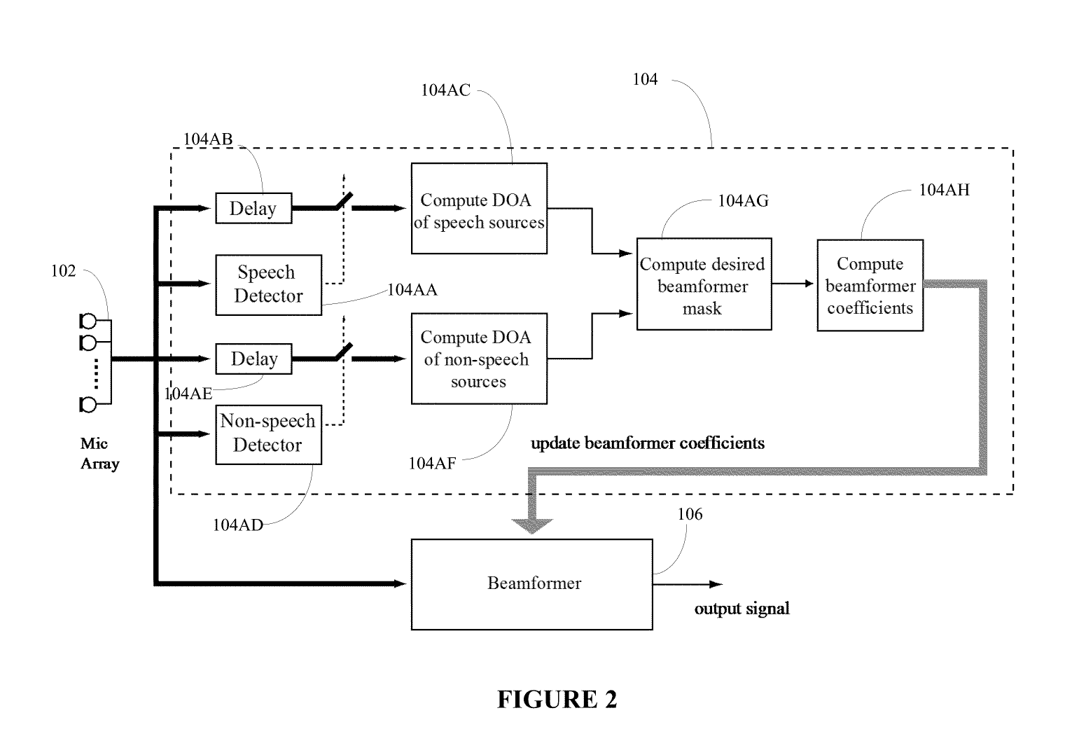

FIG. 2 illustrates a more detailed block diagram of the beamformer-coefficient processing module 104. The processing module 104 includes a speech detector 104AA, a speech-detector delay alignment 104AB, a speech DOA processor 104AC, a non-speech detector 104AD, a non-speech detector delay alignment 104AE, a non-speech DOA processor 104AF, a beamformer mask processor 104AG, and a beamformer coefficient processor 104AH.

The speech detector 104AA detects if the incoming signal from the microphone array 102 is speech; if it is speech it then the speech DOA processor 104AC computes the direction and magnitude of the speech source. The processor 104AC also stores the DOAs and magnitudes of the recent speech sources that are then passed on to the beamformer mask processor 104AG. The speech detector 104AA can also have a more detailed classifier to classify if the speech signal is from a male or female speaker, or whether it came from a certain individual.

The non-speech detector 104AD detects if the incoming signal from the microphone array 102 is not speech; if it is not speech, the non-speech DOA processor 104AF computes the direction of the speech source. The processor 104AF also stores the DOAs and magnitudes of the recent non-speech sources that are then passed on to the beamformer mask processor 104AG. The non-speech detector 104AD can also have a classifier to classify the non-speech signals in greater detail, such as from different appliances, electronic audio systems, and various types of transients and noise.

The beamformer mask processor 104AG takes in the recently detected speech and non-speech sources from modules 104AC and 104AF, respectively. Depending upon the application, the beamformer mask processor 104AG may select certain desired speech sources while suppressing the other speech and non-speech sources. In other application, it may also be possible that the processor 104AG may select certain types of non-speech sources while suppressing the other non-speech sources and speech sources.

Depending upon the application, the beamformer mask processor 104AG may use several criteria to select the speech or non-speech sources; one criteria is to select signals that are greater than a prescribed threshold with DOA lying between prescribed angular bounds. The output of the mask processor 104AG is a beamformer-response mask that is then passed on to the beamformer coefficient processor 104AH.

The beamformer coefficient processor 104AH uses the beamformer mask from the beamformer mask processor 104AG and computes the beamformer coefficients so that the beamformer response closely replicates the beamformer mask.

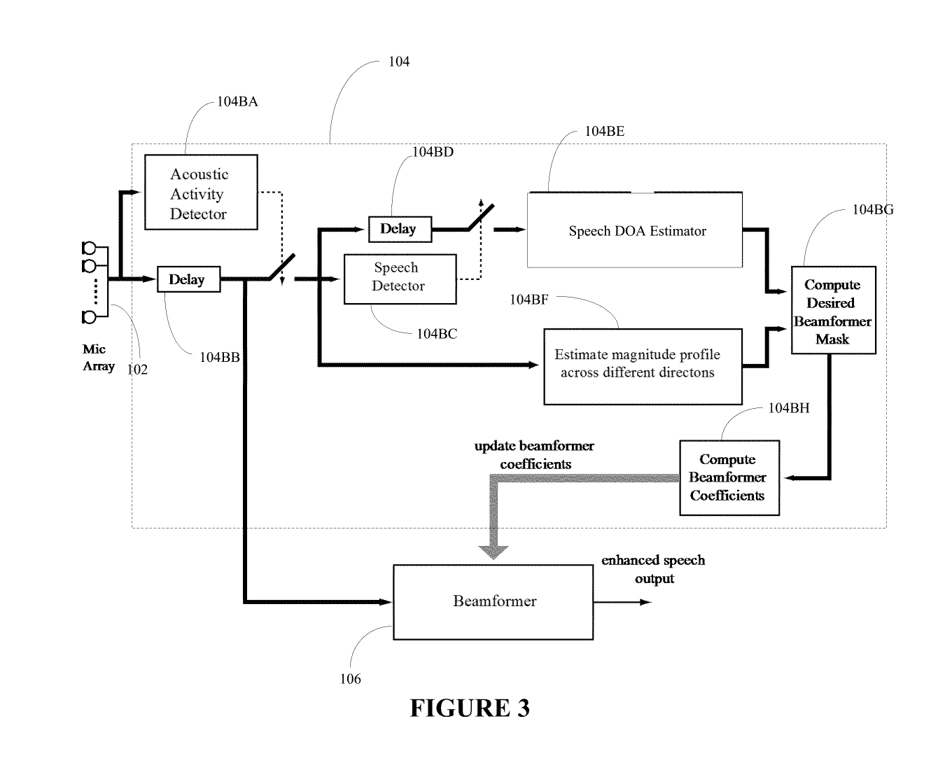

FIG. 3 illustrates a more detailed alternate realization of the block diagram of the beamformer-coefficient processing module 104. In the realization, the estimation module 104 includes an acoustic activity detector 104BA, an acoustic-activity-detector delay alignment 104BB, a speech detector 104BC, a speech-detector delay alignment 104BD, a speech DOA processor 104BE, a magnitude-profile processor across different directions 104BF, a beamformer mask processor 104BG, and a beamformer-coefficient processor 104BH.

The acoustic activity detector 104BA ensures that the computation of the beamformer coefficients is carried out only when the acoustic signal at the microphones is at a certain level above the background noise.

The speech detector 104BC detects if the incoming signal from the microphone array 102 is speech; if it is speech it then the speech DOA processor 104BE computes the direction and magnitude of the speech source. The processor 104BE also stores the DOAs and magnitudes of the recent speech sources that are then passed on to the beamformer mask processor 104BG. The speech detector 104BC may also have a more detailed classifier to classify if the speech signal is from a male or female speaker, or whether it came from a certain individual.

The magnitude-profile processor 104BF scans the acoustic signal across different directions and creates an acoustic-magnitude profile across different directions. The profile is then passed on to the beamformer mask processor 104BG.

The beamformer mask processor 104BG takes in the recently detected speech sources from the speech DOA processor 104BE and the acoustic magnitude profile from the magnitude-profile processor 104BF. Depending upon the application, the beamformer mask processor 104AG may select certain desired speech sources while suppressing the other speech and non-speech sources.

The beamformer coefficient processor 104BH uses the beamformer mask from the beamformer mask processor 104BG and computes the beamformer coefficients so that the beamformer response closely replicates the beamformer mask.

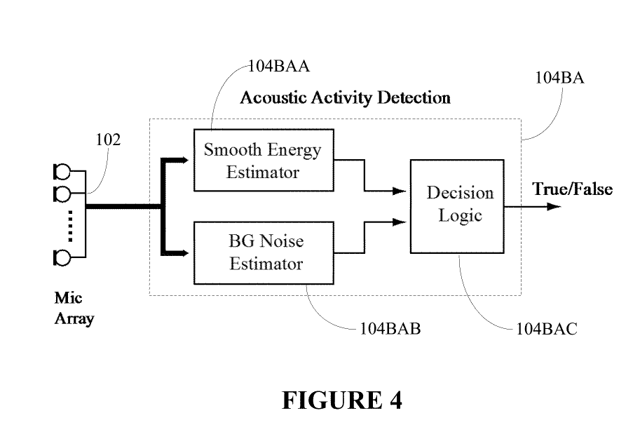

FIG. 4 illustrates a block diagram of a simple implementation of an acoustic activity detector 104BA that includes a smooth energy processor 104BAA, a background noise estimator 104BAB, and decision logic 104BAC.

The decision logic 104BAC uses the outputs of the smooth energy processor 104BAA and the background noise processor 104BAB to decide if the acoustic signal is above the estimated background noise level. For more precise detection of the acoustic activity, subband-based methods where the energy is detected across each subband using frequency-domain or wavelet-transform based analysis can also be used. In another implementation, a beamformer may also be incorporated within the acoustic activity detector 104BA so that only acoustic signals from preferred spatial directions are analyzed.

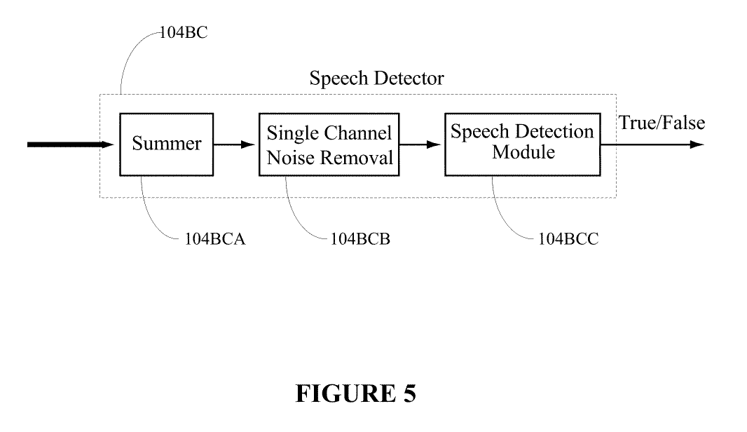

FIG. 5 illustrates a speech detector 104BC that includes a summer 104BCA, a single channel noise remover 104BCB, and a speech detection model 104BCC.

The summer 104BCA combines the signal from the microphone array to a single channel signal and passes it on to the single-channel noise remover 104BCB. The summer 104BCA may also be replaced by a beamformer so that only signals from preferred spatial directions are selected for analysis. The cleaned output from the single-channel noise remover 104BCB is then passed to a speech detection module 104BCC. The speech detection module 104BCC detects whether the input signal is speech. If speech, it outputs a TRUE value and if not a FALSE value. The speech detection module 104BCC may incorporate more detailed detectors that detect whether the speech signal corresponds to a male or a female speaker or to a particular individual.

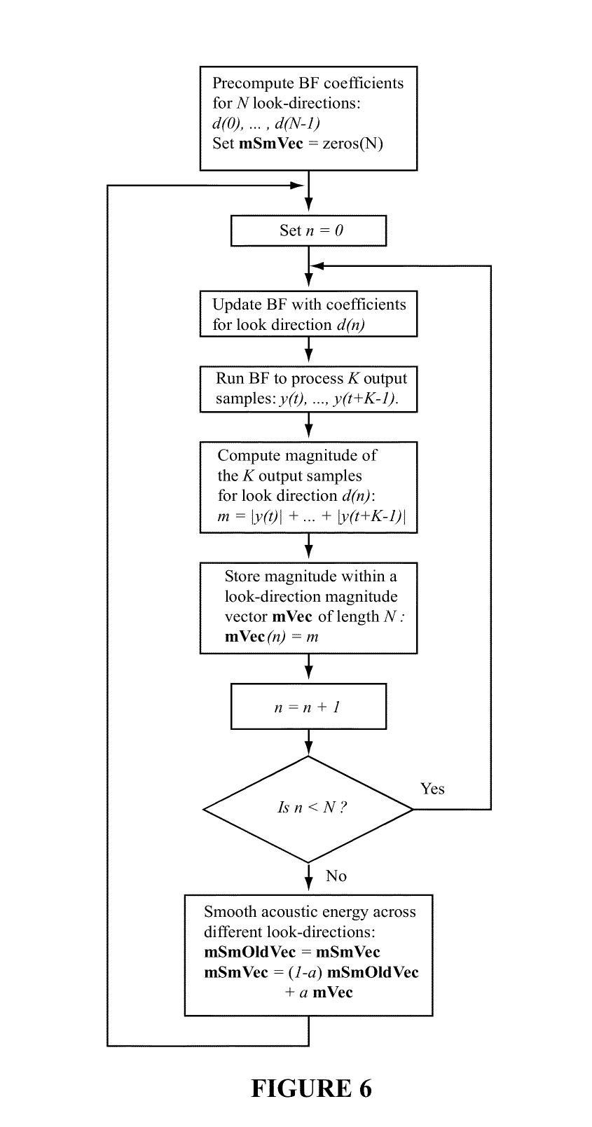

FIG. 6 illustrates a flowchart of the acoustic-magnitude profile processor 104BF to obtain the magnitude profile across various directions. In the flowchart, the beamformer is uploaded with coefficients that are pre-computed to focus in a certain direction. Then, after a prescribed interval the beamformer is update with a new set of coefficients that gradually shifts the direction of focus by a small prescribed angle. In this way, by gradually varying the beamformer angular focus across prescribed directions, the beamformer scans for acoustic signals within the indoor environment. The magnitudes of the acoustic signal scanned across the different directions are stored in a vector, mVec. A temporal leaky average of mVec is then taken to obtain a smooth profile of the magnitude of the acoustic signal across the various directions, which is stored in the vector mSmVec.

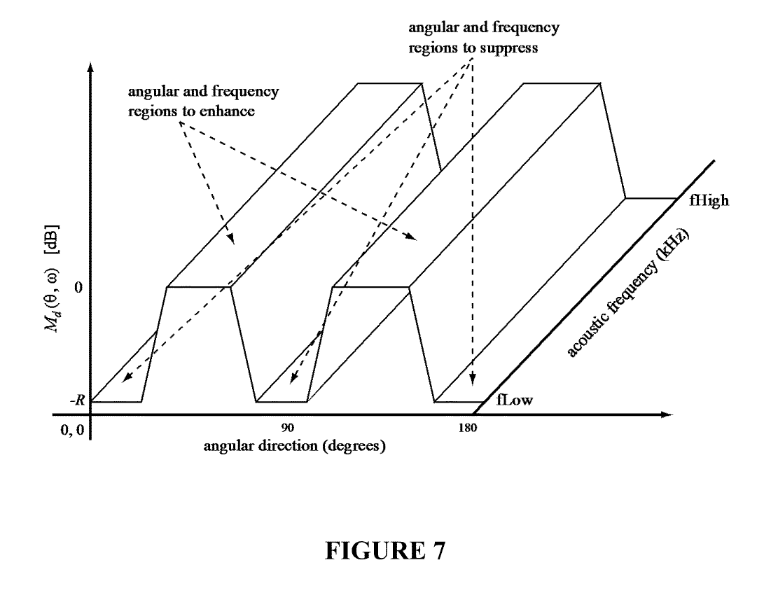

FIG. 7 illustrates a typical desired beamformer mask, M_{d}(θ, ω), across the frequency and angular directions is shown. As can be seen, the mask has two angular passbands, with frequency band lying between flow and fHigh.

The next step is to obtain a beamformer that has a magnitude response that closely replicates the mask. One new method is to optimally combine pre-computed beamformers. In the method, perfect (or near perfect) linear phase beamformer for different directions are constructed; if Mᵢ(θ, ω) is the magnitude response of the pre-computed beamformer for look-direction d(i), then the corresponding linear-phase beamformer response is given by

Bᵢ(θ, ω)=Mᵢ(θ, ω)e^{-jωτ}

A linear combination of the various linear-phase beamformers with different magnitude response is given by

$$\begin{matrix}B ( θ , ω ) = {\sum }_{i}^{ } {c}_{i} {B}_{i} ( θ , ω ) \\ = {\sum }_{i}^{ } {c}_{i} {M}_{i} ( θ , ω ) {e}^{- jωτ} \\ = M ( θ , ω ) {e}^{- jωτ}\end{matrix}$$

$$where$$

$$M ( θ , ω ) = {\sum }_{i}^{ } {c}_{i} {M}_{i} ( θ , ω )$$

and cᵢ are the weights. One way to obtain the weights, cᵢ, is to minimize the least-square error between M(θ, ω) and the beamformer mask M_{d}(θ, ω); i.e.,

minimize Σᵢ|M(θᵢ, ωᵢ)−M_{d}(θᵢ, ωᵢ)|², θᵢ∈Θ and ωᵢ∈Ω

Ifm is a vector containing the magnitude responses of the beamformer we have

$$m = {[ M ( {θ}_{1} , {ω}_{1} ) , … , M ( {θ}_{K} , {ω}_{K} ) ]}^{T} = Ac$$

$$where$$

$$A = [ \begin{matrix}{M}_{1} ( {θ}_{1} , {ω}_{1} ) & … & {M}_{L} ( {θ}_{1} , {ω}_{1} ) \\ ⋮ & ⋱ & ⋮ \\ {M}_{1} ( {θ}_{K} , {ω}_{K} ) & … & {M}_{L} ( {θ}_{K} , {ω}_{K} )\end{matrix} ]$$

$$c = {[ {c}_{1} , … , {c}_{L} ]}^{T}$$

parameters K and L are the length of the rows and columns of A. Using matrix notation the optimization problem can be expressed as

minimized ∥Ac−m_{d}μ₂²

where vector c is the optimization variable and

m_{d}=[M_{d}(θ₁, ω₁), . . . , M_{d}(θ_{K}, ω_{K})]^{T}

A closed formed solution of the optimal weights, cₒₚₜ, for the optimization problem is given by

Cₒₚₜ=(A^{T}A)⁻¹A^{T}m_{d}

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the inventive body of work is not to be limited to the details given herein, which may be modified within the scope and equivalents of the appended claims.

What is claimed is:

1. A method for enhancing desired speech sources, comprising:
determining directions of speech sources;
determining directions of non-speech sources;
determining a sound energy profile from various directions;
computing coefficients of a beamformer to enhance desired speech sources subject to the directions of the speech sources and the non-speech sources, and the sound energy profile from various directions.

2. The method of claim 1, wherein computing the coefficients of the beamformer includes:
selecting the coefficients of the beamformer to enhance desired speech sources subject to the directions of the speech sources and the non-speech sources;
selecting the coefficients of the beamformer to enhance desired speech sources subject to the directions of the speech sources and the sound energy profile;
selecting the coefficients of the beamformer to enhance desired speech sources subject to the directions of the speech sources, the non-speech sources and the sound energy profile;

3. The method of claim 1, wherein computing the coefficients of the beamformer includes:
selecting the coefficients of the beamformer to enhance sounds from prescribed zones subject to the directions of the speech sources, the non-speech sources and the sound-energy profile.

4. The method of claim 2, wherein selecting the coefficients of the beamformer includes:
determining, for each of a plurality of speech and non-speech sources, a beamformer mask for enhancing desired speech sources, while suppressing non-desired speech and non-speech sources;
determining the beamformer coefficients to closely match the beamformer mask.

5. The method of claim 4, wherein determining the beamformer coefficients to closely match the beamformer mask includes:
pre-computing the coefficients of a plurality of beamformers, where each beamformer enhances or suppresses a prescribed audio spectrum from a prescribed direction;
determining weights to combine the pre-computed beamformer coefficients so that the resulting beamformer has a magnitude response that closely matches the beamformer mask.

6. The method of claim 5, wherein determining the weights includes:
linearly combining pre-computed linear-phase beamformers in a way that a difference between the magnitude response of the resulting beamformer and the beamformer mask is minimized.

7. The method for claim 3, further comprising:
determining a beamformer mask that enhances the audio signal from prescribed directions;
pre-computing the coefficients of a plurality of beamformers, where each beamformer enhances a prescribed audio spectrum from a prescribed direction;

8. The method for claim 7, further comprising:
determining weights to combine the pre-computed beamformer coefficients so that the resulting beamformer has a magnitude response that closely matches the beamformer mask.

9. The method for claim 1, further comprising:
updating the beamformer with new coefficients after a prescribed time interval, if there is a change in the beamformer mask.

10. The method of claim 1, wherein computing the directions of the speech sources include:
determining if the signal impinging on the microphone array is speech;
when the signal is speech:
computing a direction of arrival of the signal with respect to the microphone array.

11. The method of claim 1, wherein computing the directions of the non-speech sources include:
determining if the signal impinging on the microphone array is non-speech;
when the signal is non-speech:
computing a direction of arrival of the signal with respect to the microphone array.

12. The method for claim 1, wherein computing the sound energy profile includes:
updating the beamformer so that it changes to prescribed look-directions after a fixed time interval;
computing the sound spectral energy for each of the look-directions to obtain a spectral energy profile across the prescribed directions.

13. The method for claim 12, further comprising:
temporally smoothening the sound energy profile.

14. The method for claim 1, wherein determining the sound sources includes:
determining if any acoustic activity is present in the signal.

15. The method for claim 14, wherein the presence of acoustic activity is based on:
determining smooth energy of the signal;
determining background noise of the signal.

16. The method for claim 1, wherein determining if the signal is speech or non-speech include:
summing the signal from the microphone array;
removing the background noise from the signal;
classifying if the signal is speech using a speech detection module.

17. The method of claim 5, wherein determining the weights includes:
creating a beamforming mask to enhance the zone and suppress sound sources outside the zone;
estimating the beamformer coefficients to closely match the beamformer mask;

18. The method for claim 17, wherein computing the beamformer coefficients includes:
determining the optimal weights to combine the pre-computed beamformer coefficients so that the resulting beamformer has a magnitude response that closely matches the beamformer mask
